(19) United States
(12) Patent Application Publication
(10) Pub. No.: US 2016/0065504 A1
(43) Pub. Date: Mar. 3, 2016

(54) COMMUNICATION SYSTEM AND ELECTRONIC COMPONENT MOUNTING DEVICE

(71) Applicant: FUJI MACHINE MFG. CO., LTD., Chiryu (JP)

(72) Inventors: Shigemoto HIROTA, Nagoya-shi (JP); Nobuo NAGASAKA, Okazaki-shi (JP); Takahiro JINDO, Anjyo-shi (JP)

(73) Assignee: FUJI MACHINE MFG. CO., LTD., Chiryu (JP)

(21) Appl. No.: 14/778,316

(22) PCT Filed: Mar. 20, 2013
(86) PCT No.: PCT/JP2013/057921

§ 371 Date: Sep. 18, 2015

(51) Int. Cl. H04L 12/861

(52) U.S. Cl. CPC H04L 49/9047

(57) ABSTRACT

A communication system in which a transmission line performs data transmission using multiplexing. Data extraction sections of an optical wireless device extract data output from multiple electric devices based on a start bit of the respective data, and output the data to multiple first buffers which are disposed corresponding to the electric devices. A control section selects any one of the first buffers, and outputs the data from the first buffers to a second buffer. A control section adds an identification information ID to the data indicating from which electric device the data are obtained, and stores the data in the second buffer. The data and the identification information ID of the second buffer are input to a multiplexing device from an input port. The multiplexing device multiplexes the data together with other data as a frame.

### TECHNICAL FIELD

The present disclosure relates to a communication system which performs multiplexing data communication and an electronic component mounting device which transmits data relating to board mounting work using the communication system.

### BACKGROUND ART

In the related art, as a communication system using multiplexing, a technique relating to a communication system is disclosed in which multiple subscriber-side communication devices and one station-side communication device are connected to each other (for example, PTL 1). The communication system disclosed in PTL 1 employs time compression multiplexing (TCM) in which uplink information from the subscriber-side communication device to the station-side communication device and downlink information from the station-side communication device to the subscriber-side communication device are subjected to time division, and are transmitted through the same transmission line.

In addition, as a communication system using multiplexing, for example, there is provided a time division multiplexing system (TDM: Time Division Multiplexing) in which digital signals input from multiple input ports are multiplexed so as not to temporally overlap each other and are transmitted in one direction using one transmission line. The communication system in the related art which employs time division multiplexing will be described with reference to FIG. 9. A communication system 300 illustrated in FIG. 9 is configured so that multiple (three in the illustrated example) electric devices 304A to 304C are connected to an input port disposed in a multiplexer (MUX) 302 included in a communication multiplexing device 301. For example, a data transmission rate of the respective electric devices 304A to 304C is 1 Gbps. The MUX 302 receives an input of data accumulated in a buffer of each input port at a fixed time division (time slot), multiplexes actual data 305A to 305C input to the input port from the electric devices 304a to 304C, and transmits the multiplexed data toward a receiver-side demultiplexer (DEMUX) via a transmission line 307.

### CITATION LIST

### Patent Literature

PTL 1: JP-A-2003-309579

### SUMMARY

### Technical Problem

In the communication system 300 illustrated in FIG. 9, for example, if a data transmission start signal is input to the MUX 302 from the respective electric devices 304A to 304C, the MUX 302 starts data transmission at a desired data transmission rate in mutual synchronization with the respective electric devices 304A to 304C. For this reason, if the communication system 300 intends to simply allocate a fixed time to each of the electric devices 304A to 304C so as to satisfy each data transmission rate of the respective electric devices 304A to 304C, the transmission line 307 needs to be provided with communication speed which is equal to or greater than the total value of the data transmission rates also considering a synchronization signal or the like of the multiplexing communication (in this case, 3 Gbps).

However, even if the MUX 302 starts the data transmission with the respective electric devices 304A to 304C at the desired transmission rate, in practice, the actual data 305A to 305C are asynchronously and intermittently output from the electric devices 304A to 304C. The reason is that the frequency or the like with which the respective electric devices 304A to 304C output the actual data 305A to 305C depends on device specifications or operating conditions of the electric devices 304A to 304C to be mounted thereon. As a result, for the transmission line 307, if the time that actual data 305A to 305C are not output from the respective electric devices 304A to 304C is long due to the fact that a fixed time is allocated to each of the electric devices 304A to 304C, the amount of time during which the transmission line 307 does not perform data transmission at the set communication speed (3 Gbps) increases. That is, there is a problem in that the transmission line 307 is not effectively utilized due to the increased time of no data transmission.

The disclosure is made in view of the above-described problem, and an object thereof is to provide a communication system that uses multiplexing in which efficient data transmission is performed in a transmission line, and to provide an electronic component mounting device using the communication system.

### Solution to Problem

A communication system relating to a technique disclosed in view of the above-described problem includes: multiple electric devices that output actual data in which a start bit indicating data starting is set; a data extraction section that is connected to the multiple electric devices, and that extracts the actual data based on the start bit; multiple first buffers that are disposed corresponding to each of the multiple electric devices, and that accumulate the actual data extracted by the data extraction section corresponding to the multiple electric devices; a second buffer that sequentially selects one of the multiple first buffers, and that accumulates the actual data accumulated in the selected first buffer together with identification information of the electric device which outputted the actual data; and a transmitter-side multiplexing device that inputs the actual data and the identification information from the second buffer and transmits the actual data and the identification information as multiplexed data.

In addition, an electronic component mounting device relating to a technique disclosed transmits data relating to work for mounting an electronic component on a board using the communication system relating to the technique disclosed. That is, the data is transmitted using the communication system including: the multiple electric devices that output the actual data in which the start bit indicating the data starting is set; the data extraction section that is connected to the multiple electric devices, and that extracts the actual data based on the start bit; the multiple first buffers that are disposed corresponding to each of the multiple electric devices, and that accumulate the actual data extracted by the data extraction section corresponding to the multiple electric devices; the second buffer that sequentially selects one of the multiple first buffers, and that accumulates the actual data accumulated in the selected first buffer together with identification information of the electric device which outputted the actual data; and the transmitter-side multiplexing device that inputs and the actual data and the identification information from the second buffer and transmits the actual data and the identification information as the multiplexed data.

### Advantageous Effects

According to a communication system and an electronic component mounting device which relate to a technique disclosed, a transmission line is enabled to perform efficient data transmission in the communication system that uses multiplexing.

### BRIEF DESCRIPTION OF DRAWINGS

FIG. 1 is a perspective view of an electronic component mounting device to which a communication system according to the present embodiment is applied.

FIG. 2 is a schematic plan view illustrating a state where an upper cover is detached from the electronic component mounting device illustrated in FIG. 1.

FIG. 3 is a block diagram of the electronic component mounting device.

FIG. 4 is a block diagram illustrating a configuration relating to transmission of an optical wireless device.

FIG. 5 is a timing chart illustrating a transmission state of data which is input to the optical wireless device from each camera.

FIG. 6 is a diagram illustrating a state of data which is temporarily stored in a second buffer.

FIG. 7 is a diagram illustrating an example of a data stream of a frame which is subjected to time division multiplexing.

FIG. 8 is a block diagram illustrating a configuration relating to reception of the optical wireless device.

FIG. 9 is a configuration diagram for describing a multiplexing communication system used as a comparative example.

### DESCRIPTION OF EMBODIMENT

Hereinafter, an embodiment of the disclosure will be described with reference to the drawings. First, as an example of a device to which a communication system according to the disclosure is applied, an electronic component mounting device (hereinafter, sometimes abbreviated to “mounting device”) will be described.

### (Configuration of Mounting Device 10)

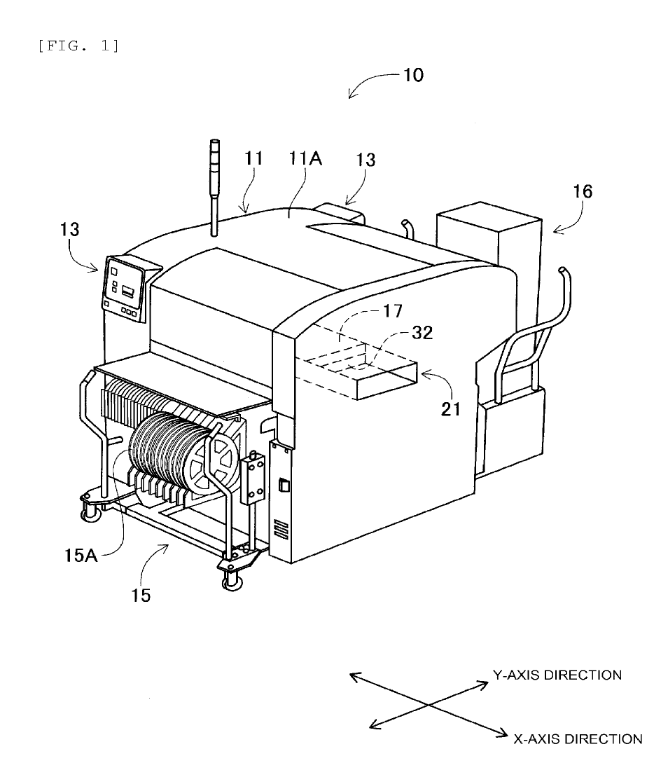

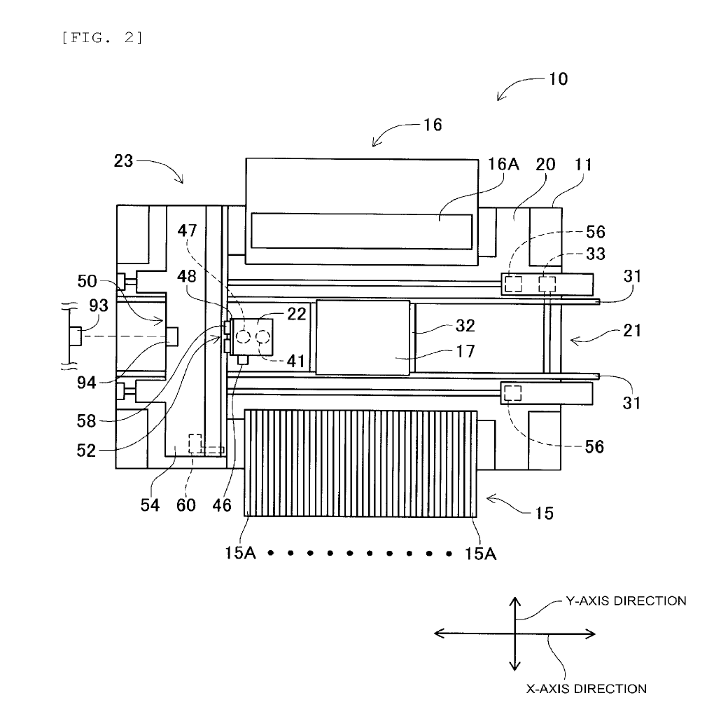

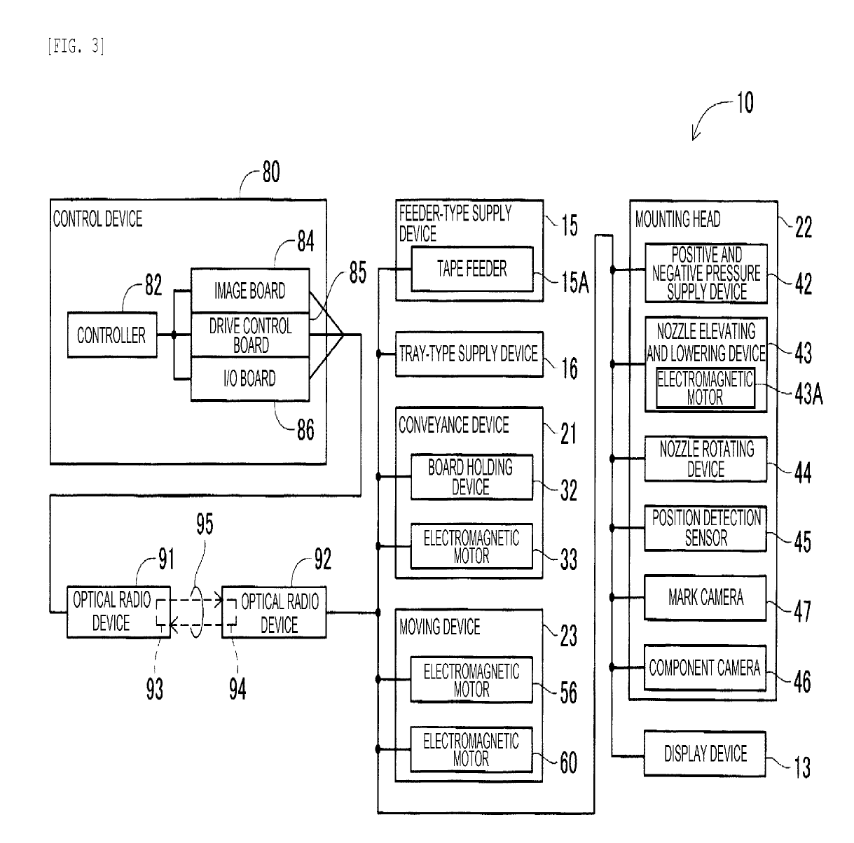

As illustrated in FIG. 1, amounting device 10 includes a device body 11, a pair of display devices 13 disposed integrally with the device body 11, and supply devices 15 and 16 disposed so as to be attachable to and detachable from the device body 11. The mounting device 10 according to the present embodiment is a device which carries out work for mounting an electronic component (not illustrated) on a circuit board 17 conveyed by a conveyance device 21 accommodated inside the device body 11, based on control of a control device 80 illustrated in FIG. 3. In order to describe the present embodiment, as illustrated in FIG. 1, a direction in which the circuit board 17 is conveyed by the conveyance device 21 (lateral direction in FIG. 2) is referred to as an X-axis direction, and a direction which is perpendicular to the X-axis direction and horizontal with the conveyance direction of circuit board 17 is referred to as a Y-axis direction.

The device body 11 includes the respective display devices 13 in both end portions in the Y-axis direction on one end side in the X-axis direction. The respective display devices 13 are touch panel-type display devices, and display information relating to the work for mounting the electronic component. In addition, the device body 11 includes the supply devices 15 and 16 which are mounted so as to interpose the device body 11 therebetween from both sides in the Y-axis direction. The supply device 15 is a feeder-type supply device, and has multiple tape feeders 15A in which various electronic components are accommodated in a state taped and wound around a reel. The supply device 16 is a tray-type supply device, and has multiple component trays 16A (refer to FIG. 2) on which multiple electronic components are placed.

FIG. 2 is a schematic plan view illustrating the mounting device 10 when viewed from above (from the upper side in FIG. 1) in a state where an upper cover 11A (refer to FIG. 1) is detached from the device body 11. As illustrated in FIG. 2, the device body 11 includes a base 20 on which the above-described conveyance device 21, a mounting head 22 which mounts the electronic components on the circuit board 17, and a moving device 23 which moves the mounting head 22 are provided.

The supply devices 15 and 16 are respectively connected to each side surface portion in the Y-axis direction of the base 20. The respective supply devices 15 and 16 are detachably attached to the base 20 in order to cope with a lack of the electronic components to be supplied or a change in types of the electronic components and the like. The conveyance device 21 is disposed substantially in the center of the base 20 in the Y-axis direction, and has a pair of conveyor belts 31, a board holding device 32 held in the conveyor belts 31, and an electromagnetic motor 33 for moving the board holding device 32. The board holding device 32 holds the circuit board 17. An output shaft of the electromagnetic motor 33 is connected to the conveyor belts 31 so as to drive the conveyor belts 31. For example, the electromagnetic motor 33 is a servo motor which can accurately control a rotation angle. With the conveyance device 21, the conveyor belts 31 perform a turning operation based on the driving of the electromagnetic motor 33, thereby causing the board holding device 32 and the circuit board 17 to move in the X-axis direction.

The mounting head 22 has a suction nozzle 41 for picking up the electronic component, on a lower surface facing the circuit board 17. Negative air pressure and positive air pressure are supplied to the suction nozzle 41 by a positive and negative pressure supply device 42 illustrated in FIG. 3 through a negative pressure air passage and a positive pressure air passage such that the suction nozzle 41 picks up and holds the electronic component using negative pressure, and releases the held electronic component by slight positive pressure being supplied. In addition, as illustrated in FIG. 3, the mounting head 22 has a nozzle raising and lowering device 43 for raising and lowering the suction nozzle 41, and a nozzle rotating device 44 for rotating the suction nozzle 41 around an axis; a vertical position of the held electronic component and a holding posture of the electronic component are changed based on the control of the control device 80. The nozzle raising and lowering device 43 includes an electromagnetic motor 43A serving as a drive source. In addition, the mounting head 22 has a position detection sensor 45 for detecting the vertical position of the held electronic component.

In addition, the mounting head 22 has two imaging devices of a component camera 46 and a mark camera 47. For example, the component camera 46 and the mark camera 47 have an incorporated imaging element such as a CMOS sensor, a CCD sensor, and the like. The component camera 46 is disposed at a position where an end portion of the suction nozzle 41 can be imaged from a lateral surface side (for example, lateral surface side when viewed in the Y-axis direction in FIG. 2). The component camera 46 images the electronic component which is picked up and held by the suction nozzle 41 from the respective supply devices 15 and 16. The mark camera 47 is fixed at a position where the circuit board 17 can be imaged in a state of facing downward from the mounting head 22. The mark camera 47 images a reference position mark of the circuit board 17 or a mounting state of the electronic component and the like. The suction nozzle 41 is attachable to and detachable from the mounting head 22, and can be changed depending on the size, shape, or the like of the electronic component. In addition, the mounting head 22 may be configured to include multiple suction nozzles 41 so that the suction nozzle 41 can be changed depending on the mounting state.

In addition, the mounting head 22 is moved to any desired position on the base 20 by the moving device 23 illustrated in FIG. 2. More specifically, the moving device 23 includes an X-axis-direction slide mechanism 50 for moving the mounting head 22 in the X-axis direction and a Y-axis-direction slide mechanism 52 for moving the mounting head 22 in the Y-axis direction. The X-axis-direction slide mechanism 50 has an X-axis slider 54 disposed on the base 20 so as to be movable in the X-axis direction and an electromagnetic motor 56 (refer to FIG. 3) serving as a drive source. The X-axis slider 54 is moved to any desired position in the X-axis direction based on the driving of the electromagnetic motor 56.

The Y-axis-direction slide mechanism 52 has a Y-axis slider 58 disposed on a side surface of the X-axis slider 54 so as to be movable in the Y-axis direction and an electromagnetic motor 60 (refer to FIG. 3) serving as a drive source. The Y-axis slider 58 is moved to any desired position in the Y-axis direction based on the driving of the electromagnetic motor 60. The mounting head 22 is attached to the Y-axis slider 58, and is moved to any desired position on the base 20 in response to the driving of the moving device 23. In this manner, when the mounting head 22 is moved, the mark camera 47 can image a surface at any desired position of the circuit board 17. In addition, the mounting head 22 is attached to the Y-axis slider 58 via a connector 48, and can be detached therefrom with a single touch; thus, the mounting head 22 can be changed to various different work heads, for example, a dispenser head.

### (Communication System Applied to Mounting Device 10)

As illustrated in FIG. 3, the mounting device 10 according to the present embodiment is configured to use optical wireless multiplexing communication for data communication between a control device 80 of the mounting device 10 and portions other than the control device 80 (various devices). A configuration of the mounting device 10 illustrated in FIG. 3 is an example of applying the communication system, and is appropriately changed depending on the type or the number of devices included in the mounting device 10. In addition, the communication system according to the disclosure is a system which can be applied to an automatic machine operated in various production lines in addition to the electronic component mounting device represented by the mounting device 10.

As illustrated in FIG. 3, the control device 80 includes a controller 82 whose main body is a computer including a CPU or the like, an image board 84, a drive control board 85, and an I/O board 86. The controller 82 controls the respective boards 84, 85, and 86 so as to perform data transmission with various devices. Optical wireless devices 91 and 92 perform the data transmission through a transmission line 95 established by optical wireless communication. The respective boards 84, 85, and 86 are connected to the optical wireless device 91, and input and output data of the respective boards 84, 85, and 86 is transmitted between the optical wireless device 91 and the optical wireless device 92. The optical wireless device 92 is incorporated in the moving device 23, for example, and various devices (camera, motor, sensor, or the like) are connected thereto. As illustrated in FIG. 2, the moving device 23 has a light emitting and receiving section 94 of the optical wireless device 92 which is disposed so as to face a light emitting and receiving section 93 of the optical wireless device 91 which is connected to the control device 80. The light emitting and receiving section 94 is fixed to the X-axis slider 54 of the moving device 23 so that an optical axis is coincident with that of the light emitting and receiving section 93 on the optical wireless device 91 side. In this manner, various types of information communication are possible between the light emitting and receiving sections 93 and 94 (optical wireless devices 91 and 92).

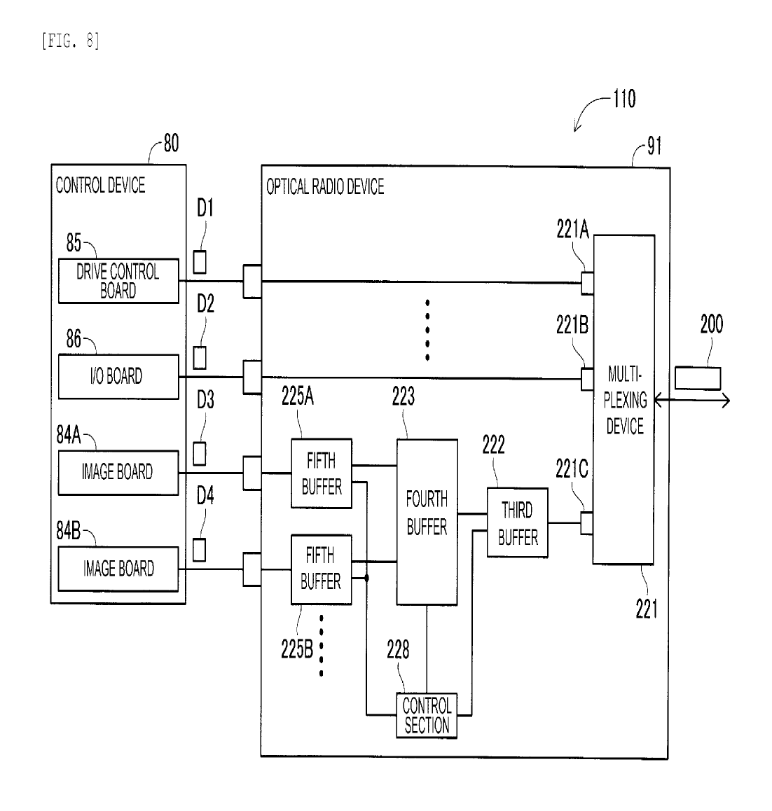

The image board 84 illustrated in FIG. 3 is a board for controlling an input and an output of image data. The component camera 46 and the mark camera 47 of the mounting head 22 output captured image data to the optical wireless device 92. The image board 84 may be configured to include multiple boards corresponding to each of the component camera 46 and the mark camera 47 (refer to image boards 84A and 84B in FIG. 8). The optical wireless device 92 transmits the image data output from the component camera 46 and the mark camera 47 toward the image board 84 of the control device 80. The drive control board 85 is a board for controlling an input and an output of a command to operate electromagnetic motors, or information which is fed back from the electromagnetic motors on a real-time basis. For example, the controller 82 receives servo control information such as torque information or position information (vertical position of the electronic component held by the suction nozzle 41) which is acquired from the electromagnetic motor 43A via the drive control board 85. The I/O board 86 is a board for controlling an I/O signal such as an output signal of the position detection sensor 45. The data input to the control device 80 from each device is multiplexed by the optical wireless device 92, and thereafter is transmitted through the transmission line 95 as an optical wireless signal. The optical wireless device 91 performs a process of demultiplexing and dividing the transmitted multiple signal into individual data. The optical wireless device 91, from the divided data, transmits the image data to the image board 84, transmits the servo control information to the drive control board 85, and transmits the I/O signal to the I/O board 86.

In contrast, the controller 82 processes each data received by the optical wireless device 91. For example, the controller 82 outputs a control signal for controlling the electromagnetic motor 43A based on the processing result to the optical wireless device 91 via the drive control board 85. The optical wireless device 92 transmits the control signal transmitted from the optical wireless device 91 to the nozzle raising and lowering device 43. The electromagnetic motor 43A is operated based on the control signal. In addition, for example, the controller 82 transmits the control signal for changing a display of the display device 13 to the display device 13 via the I/O board 86 and the optical wireless devices and 92. As described above, various information transmitted and received between the control device 80 and the respective devices other than the control device 80 is transmitted and received through the transmission line 95 as frame data multiplexed by time division multiplexing (TDM: Time Division Multiplexing). A data transmission rate of the time division multiplexing communication between the optical wireless devices 91 and 92 is 3 Gbps, for example.

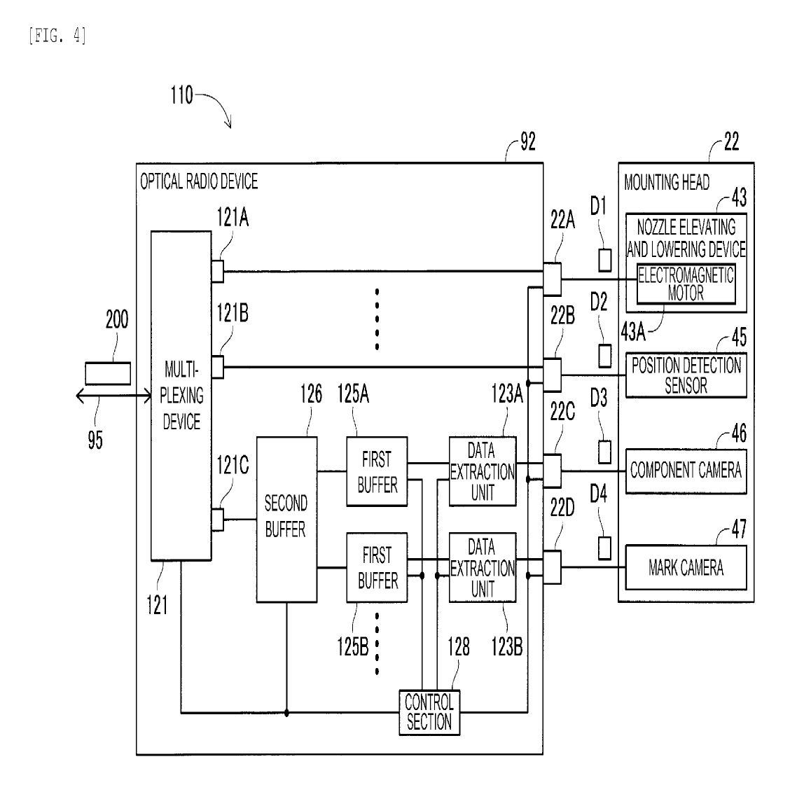

Described below is the preferred communication system applied to the mounting device 10 which mounts the electronic components using the above-described time division multiplexing communication system. A multiplexing communication system 110 illustrated in FIGS. 4 and 8 represents a communication system which connects the mounting head 22 and the control device 80 to each other, as an example of the communication system. In addition, in order to facilitate understanding, description will be made by referring to the mounting head 22 as a transmitter-side and the control device 80 as a receiver-side. The data transmission from the control device 80 to the mounting head 22 is the same as the data transmission from the mounting head 22 to the control device 80, and thus description thereof will be appropriately omitted. Therefore, FIG. 4 illustrates only a configuration relating to the transmission of the optical wireless device 92, and FIG. 8 illustrates only a configuration relating to the reception of the optical wireless device 91.

The optical wireless device 92 illustrated in FIG. 4 includes a multiplexing device 121 having multiple (only three are illustrated in the drawing) input ports 121A to 121C disposed therein. The mounting head 22 includes the nozzle raising and lowering device 43 (electromagnetic motor 43A), the position detection sensor 45, the component camera 46, and the mark camera 47; each of connectors 22A to 22D connected to the respective devices 43A, 45, 46, and 47 is connected to the optical wireless device 92.

Data D1 such as the servo control information output from the electromagnetic motor 43A is input to the input port 121A of the multiplexing device 121 via the connector 22A. A data transmission rate of the electromagnetic motor 43A is 125 Mbps, for example. In addition, data D2 such as the I/O signal output from the position detection sensor 45 is input to the input port 121B of the multiplexing device 121 via the connector 22B. A data transmission rate of the position detection sensor 45 is several kbps, for example. Data D3 such as the image data output from the component camera 46 is input to the input port 121C of the multiplexing device 121 via the connector 22C. Data D4 such as the image data output from the mark camera 47 is input to the input port 121C of the multiplexing device 121 via the connector 22D. A data transmission rate of each of the component camera 46 and the mark camera 47 is 1.5 Gbps, for example.

A buffer (not illustrated) is disposed in the respective input ports 121A to 121C, and the data D1 to D4 are temporarily accumulated therein. The multiplexing device 121 receives the input of the data D1 to D4 accumulated in the buffer of the respective input ports 121A to 121C at a fixed time division (time slot). The multiplexing device 121 multiplexes the data D1 to D4 input to the respective input ports 121A to 121C into a time-divided frame 200, and transmits the frame 200 through the transmission line 95.

Here, in cases in which the data D1 to D4 are not input in spite of the fact that the fixed time is allocated to each of the input ports 121A to 121C, the multiplexing device 121 performs data transmission for the data region allocated to the respective input ports 121A to 121C within a time-divided data region of the frame 200 without the data D1 to D4 being included. Therefore, if the time during which the data D1 to D4 are not transmitted from the respective devices 43A, 45, 46, and 47 becomes long, the time during which the transmission line 95 does not perform data transmission at the set communication speed (for example, 3 Gbps) increases.

In addition, in a case of the data D1 to D4, transmission frequency or allowable delayed time varies depending on the applicable communication system. For example, the control device 80 (refer to FIG. 3) performs drive control on the electromagnetic motor 43A based on the servo control information which is fed back from the electromagnetic motor 43A on a real-time basis. In addition, the control device 80 determines a vertical position of the electronic component held by the suction nozzle 41 based on the I/O signal output from the position detection sensor 45, and adjusts the vertical position by driving the electromagnetic motor 43A. Therefore, the data D1 and D2 output from the electromagnetic motor 43A and the position detection sensor 45 are needed as feedback control data for controlling the electromagnetic motor 43A on a real-time basis; accordingly, if there is a delay in the data transmission, the control for the driving electromagnetic motor 43A is delayed. Therefore, it is preferable to transmit the data D1 and D2 without any delay irrespective of the transmission frequency.

In contrast, for example, if the electronic component is held by the suction nozzle 41 from the supply devices 15 and 16 during the mounting work, the component camera 46 outputs the data D3 after performing image processing. In addition, for example, when it is necessary to confirm a reference position mark of the circuit board 17, the mark camera 47 outputs the data D4 after performing image processing. That is, the data D3 and D4 have different data transmission frequencies with which the data is transmitted at the timing according to each work process and the data is not transmitted at the other timings.

In addition, based on the data D3 and D4 output from the respective cameras 46 and 47, the controller 82 determines a position of the electronic component held by the suction nozzle 41 (refer to FIG. 2) and a position of the circuit board 17, and calculates an error between the mutual positions and the like. That is, the data D3 and D4 are used in calculating a movement amount or the like for correcting the error between the electronic component and the circuit board 17; accordingly, compared to the data D1 and D2, the delayed data transmission of the data D3 and D4 exerts a smaller influence on the mounting work.

In addition, compared to the electromagnetic motor 43A or the position detection sensor 45, the respective cameras 46 and 47 have a higher data transmission rate and a higher ratio at which the data D3 and D4 occupy communication capacity of the transmission line 95. Accordingly, the transmission line 95 can perform more efficient data transmission by optimizing the data transmission of the data D3 and D4. Therefore, the optical wireless device 92 according to the present embodiment includes data extraction sections 123A and 123B, first buffers 125A and 125B, a second buffer 126, and a control section 128, and is configured to accumulate both the data D3 and D4 in the first and second buffers 125A, 125B, and 126 so as to output the data D3 and D4 to one input port 121C.

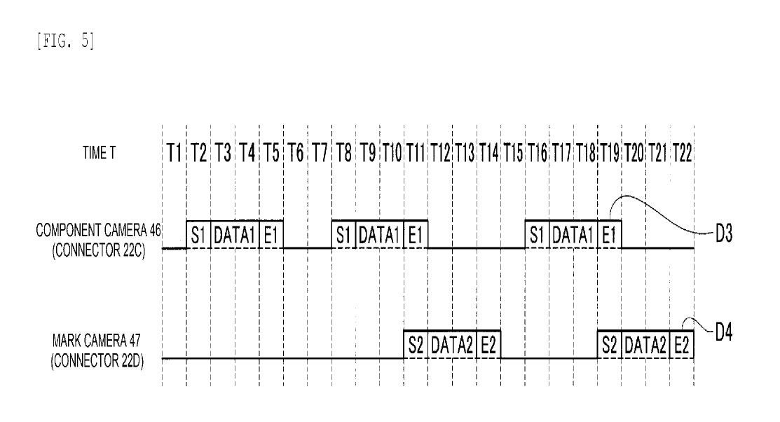

FIG. 5 illustrates a data transmission state of the data D3 and D4 output from the respective cameras 46 and 47 to the connectors 22C and 22D. As illustrated in FIG. 5, the data D3 is a data stream set by ratings and the like of the component camera 46; for example, a start bit S1 is added to the head of data 1 for one line of one frame image data, and an end bit E1 is added to the tail. In addition, the data D4 is a data stream set by ratings and the like of the mark camera 47. A start bit S2 is added to the head of data 2, and an end bit E2 is added to the tail. For example, the start bits S1 and S2 and the end bits E1 and E2 are predetermined bit values or data including the bit values.

The data extraction sections 123A and 123B illustrated in FIG. 4 are one-to-one associated with the respective cameras 46 and 47. The data extraction section 123A is connected to the connector 22C, and extracts the data D3 output from the component camera 46 based on the start bit S1. In addition, the data extraction section 123B is connected to the connector 22D, and extracts the data D4 output from the mark camera 47 based on the start bit S2. A data format of the above-described data D3 and D4 is an example; the data D3 may be a data stream to which the end bit E1 is not added, for example. In this case, for example, the data extraction section 123A detects the data D3 by using a preset bit width from the start bit S1. In addition, for example, the data D3 maybe configured so that the data 1 in each data stream may has a different bit width. In addition, for example, in the data D3, the start bit S1 may include data other than the bit value which indicates the head.

The data extraction section 123A outputs the extracted data D3 to the first buffer 125A. In addition, the data extraction section 123B outputs the extracted data D4 to the first buffer 125B. For example, the second buffer 126 is a first-in-first-out (FIFO) buffer, and sequentially reads the data D3 and D4 accumulated in the first buffers 125A and 125B. For example, if a write request signal of the first buffers 125A and 125B is input, the control section 128 performs a process of reading the data D3 and D4 from the first buffers 125A and 125B which make a write request to the second buffer 126.

For example, the control section 128 performs data writing from the first buffer 125A to the second buffer 126 until the end bit E1 is detected. In this manner, one data D3 is written to the FIFO second buffer 126 as a one continuous block of data. In addition, if the write request signal of the other first buffer 125B is input when the write process is completed from the first buffer 125A, the control section 128 performs the write process from the first buffer 125B to the second buffer 126. Alternatively, if the write request signal of the first buffer 125B is not input and the write request signal is continuously input from the first buffer 125A, the control section 128 continuously performs the process of writing from the first buffer 125A. In this manner, the control section 128 sequentially processes each write request signal of the first buffers 125A and 125B.

Priority may be set in the write request of the first buffers 125A and 125B. For example, a configuration may be adopted in which the priority is set in the write request signal of the first buffers 125A and 125B depending on the type of the data D3 and D4 or the transmission frequency during the work process, and in which the control section 128 performs a write process or an interruption process of the data D3 and D4 in accordance with the priority. Alternatively, a configuration may be adopted in which a processing circuit is disposed in the second buffer 126 so that the second buffer 126 sequentially monitors the write request signal of the first buffers 125A and 125B.

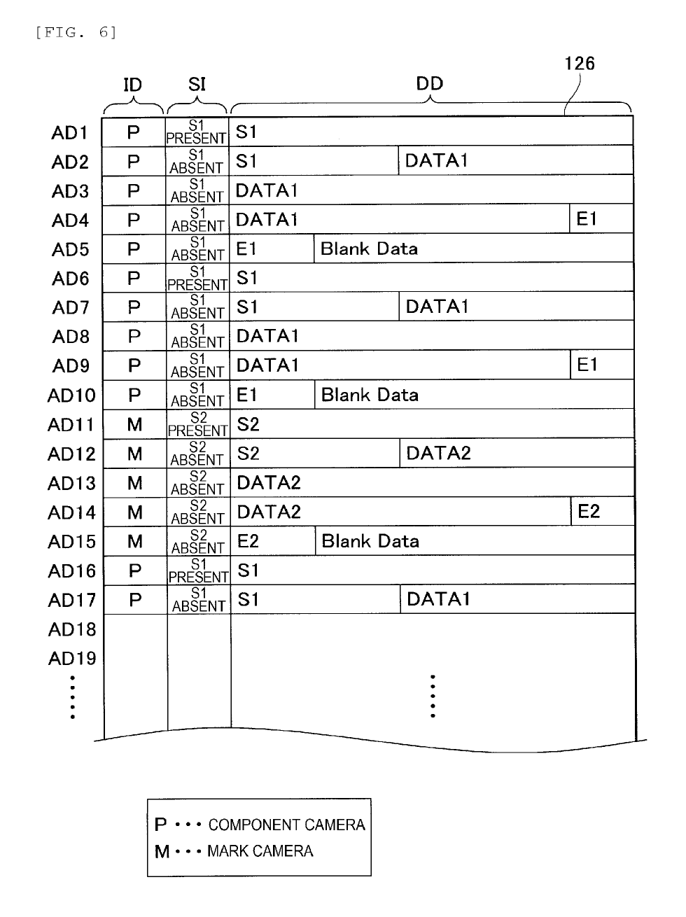

FIG. 6 illustrates an example of a state of the second buffer 126 which stores the data D3 and D4. For example, in the second buffer 126, a memory is managed by being divided into multiple data regions, and the control section 128 performs read and write processes based on a head address (address AD1 or the like in the drawing) of each data region. For example, the control section 128 cyclically stores the data D3 and D4 in each data region in the order of addresses AD1, AD2, AD3, and so on, and outputs the data D3 and D4 in the order in which they were input (for example, data located on the upper side in the drawing). For example, during the time T2 to T5 illustrated in FIG. 5, the data D3 is output to the first buffer 125A from the component camera 46. The control section 128 detects the write request signal of the first buffer 125A, and stores the data D3 accumulated in the first buffer 125A in the second buffer 126. At this time, the control section 128 performs a storing process by dividing the data D3 into data regions of the addresses AD1 to AD5 of the second buffer 126.

The control section 128 divides the data D3 into multiple divided data DD, and stores the multiple divided data DD. In addition, the control section 128 divides and stores the data, and adds an identification information ID and start bit information SI to the head of the divided data DD. The identification information ID represents information indicating that the divided data DD is any data of the data D3 and D4, that is, identification information P, M indicating from which device out of the component camera 46 and the mark camera 47 the divided data comes. Therefore, the information P indicating that the divided data is obtained from the component camera 46 is stored in the identification information ID stored in the data region of the addresses AD1 to AD5.

In addition, the start bit information SI is information indicating in which divided data DD the start bits S1 and S2 of each of the data D3 and D4 are included. For example, the data D3 is divided into and stored in the addresses AD1 to AD5, and a start bit S1 head portion is included in the divided data DD of the address AD1. Therefore, information indicating that the start bit S1 is stored (“S1 present” in the drawing) is stored in the start bit information SI stored in the data region of the address AD1. In addition, information indicating that the start bit S1 is not stored (“Si absent” in the drawing) is stored in the start bit information SI of the address AD2 to AD5 which store the other divided data. Incidentally, the control section 128 sets blank data (for example, all bit values show “0”) which is not processed on the receiver-side in the data region excluding the end bit E1 for the divided data DD stored in the address AD5, which is the tail address out of the addresses AD1 to AD5 in which the divided data DD is stored.

In addition, during the time T8 to T11 illustrated in FIG. 5, the data D3 is input from the component camera 46 to the first buffer 125A. For example, at the time T8, since there is no write request from the other first buffer 125B, the control section 128 detects the write request of the first buffer 125A and stores the data D3 in the data region of the addresses AD6 to AD10 as the divided data DD.

In addition, during the time T11 to T14 illustrated in FIG. 5, the data D4 is input from the mark camera 47 to the first buffer 125B. The control section 128 detects the write request signal of the first buffer 125B, and stores the data D4 accumulated in the first buffer 125B in the data region of the addresses AD11 to AD15 of the second buffer 126 as the divided data DD. The control section 128 sets the information M indicating the divided data is obtained from the mark camera 47 in the identification information ID of the addresses AD11 to AD15. In addition, the control section 128 sets information indicating that the start bit S2 is stored in the start bit information SI of the address AD11.

The data D3 and D4 accumulated in the second buffer 126 are output to the input port 121C of the multiplexing device 121 illustrated in FIG. 4. The multiplexing device 121 allocates a fixed time to the input port 121C, inputs the data D3 and D4 from the second buffer 126, multiplexes the data D3 and D4 together with the data D1 and D2 input to the other input ports 121A and 121B, and transmits the data as the frame 200.

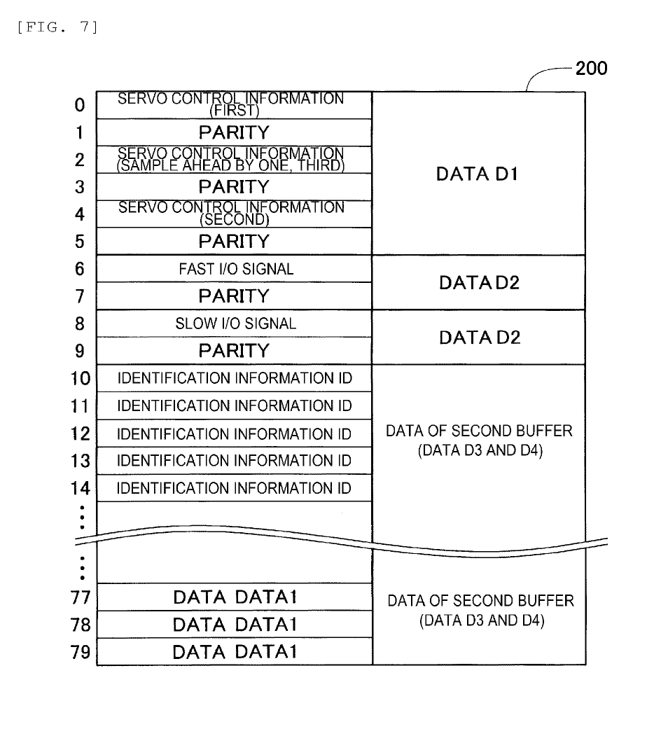

FIG. 7 illustrates an example of a data stream in the multiplexed frame 200. The frame 200 illustrated in FIG. 7 is illustrated by omitting a control signal such as a synchronization signal used for multiplexing communication between the optical wireless devices 91 and 92. For example, the multiplexing device 121 transmits the frame 200 in which one frame has 80 bits, at a data transmission rate of 3 Gbps. As illustrated in FIG. 7, for the data D1, six bits from 0th to 5th bits are secured as a bit width per one frame 200. In addition, the multiplexing device 121 has an error correction function, and performs error correction on the data D1 input to the input port 121A. For example, the multiplexing device 121 performs an error correction process on the data D1 by using majority logic which determines a data value contained in a majority of multiple transmissions as a correct data value. The number of repeated transmissions when servo control information of one bit is decided by the majority logic is set to three times, for example. In the data D1, a parity bit of one bit is provided for every one bit of the servo control information, and thus six bits corresponding to an amount of three times are transmitted in total. Incidentally, in an example illustrated in FIG. 7, the servo control information of the second bit represents the third transmission with regard to the servo control information of a sample ahead by one. As described above, the frame 200 to be transmitted is changed to a different frame 200 for at least one transmission among the three transmissions, thus, it is possible to reliably perform the data transmission by reducing the probability of receiving an influence of burst errors.

In addition, for the I/O signal, four bits, that is the 6th to 9th bits, are secured as the bit width per one frame 200, and the 6th bit for a fast I/O signal and the 8th bit for a slow I/O signal are set. For example, in a case of the 6th bit for the fast I/O signal, a signal of the position detection sensor 45 which requires a fast response time is transmitted per every frame 200. In addition, the 7th bit for the slow I/O signal represents the other I/O signal in which delayed data is allowed compared to the position detection sensor 45, for example, a confirmation signal of lamp lighting. In the frame 200, one bit width is secured for multiple lamps, thus, the signal of each lamp is sequentially set in the 8th bit of the multiple frames 200, and is transmitted. The multiplexing device 121 performs the error correction process by providing parity symbols after each bit of the 6th bit and the 8th bit. In addition, classification of the above-described I/O signal is an example, and a configuration may be adopted in which the slow I/O signal is classified in a hierarchical manner (slow speed, extremely slow speed, or the like) so as to sequentially transmit the signal of each I/O device, for example.

The data (the identification information ID, the start bit information SI, and the divided data DD) relating to the data D3 and D4 of the second buffer 126 is set in the remaining 70 bits, that is the 10th to 79th bits, of the frame 200. The multiplexing device 121 inputs the data relating to the data D3 and D4 of the second buffer 126 from the input port 121C, and transmits the data as the 10th to 79th bits of the frame 200. The multiplexing device 121 may include a circuit for performing the error correction process on the data D3 and D4, for example, a forward error correction process. In this case, a forward error symbol is included in the 10th to 79th bits of the frame 200. In addition, if the data relating to the data D3 and D4 is not accumulated in the second buffer 126, the multiplexing device 121 sets and transmits blank data to the 10th to 79th bits of the frame 200. In addition, the multiplexing device 121 sets and transmits blank data to the 10th to 79th bits of the frame 200 in a region excluding a region where the data (the identification information ID, the start bit information SI, and the divided data DD) relating to the data D3 and D4 is set. For example, the multiplexing device 121 sets blank data in the region remaining after the multiple divided data DD are set in the 10th to 79th bits.

FIG. 8 illustrates a configuration relating to the reception of the optical wireless device 91. The optical wireless device 91 includes a multiplexing device 221 having multiple (three are illustrated in the drawing) output ports 221A to 221C disposed therein, a third buffer 222, a fourth buffer 223, multiple (two are illustrated in the drawing) fifth buffers 225A and 225B, and a control section 228. In addition, the optical wireless device 91 is connected to the control device 80; the drive control board 85, the I/O board 86, and the two image boards 84A and 84B are connected to the optical wireless device 91. The multiplexing device 221 performs demultiplexing on the frame 200 transmitted from the multiplexing device 121 of the optical wireless device 92, divides the frame into individual data, and outputs the data to the output ports 221A to 221C. The communication system 110 illustrated in FIG. 8 adopts a configuration in which the control device 80 includes the image boards 84A and 84B which are one-to-one associated with each of the component camera 46 and the mark camera 47.

The data D1 output from the electromagnetic motor 43A is output to the drive control board 85 from the output port 221A of the multiplexing device 221. In addition, the data D2 output from the position detection sensor 45 is output to the I/O board 86 from the output port 221B of the multiplexing device 221. In addition, the multiplexing device 221 outputs the data relating to the data D3 and D4, that is, the data from the 10th to 79th bits of the frame 200 illustrated in FIG. 7, from the output port 221C to the third buffer 222.

Here, if the data D3 and D4 are not accumulated in the second buffer 126 when the transmitter-side optical wireless device 92 receives the input of the input port 121C, all the data of the 10th to 79th bits of the frame 200 become blank data. The control section 228 determines whether effective data (the identification information ID or the like) is included in the data output from the output port 221C of the multiplexing device 221 to the third buffer 222. For example, based on the identification information ID and the start bit information SI, the control section 228 detects the divided data DD, and stores the data ranging from the identification information ID to the divided data DD in the third buffer 222 as one data unit. In addition, if the identification information ID or the like is not detected, the control section 228 determines the data stored in the third buffer 222 as blank data and deletes the data.

Similarly to the second buffer 126 of the optical wireless device 92, the fourth buffer 223 is a first-in-first-out (FIFO) buffer, for example (refer to FIG. 6). The control section 228 stores the identification information ID, the start bit information SI, and the divided data DD which are output from the third buffer 222, in a data region indicated by each head address in a memory of the fourth buffer 223, as one data unit. In addition, based on the control from the control section 228, the fourth buffer 223 rebuilds the data D3 and D4 from the divided data DD, and outputs the data D3 and D4 to the fifth buffers 225A and 225B. The fifth buffer 225A is connected to the image board 84A which processes the data D3 of the component camera 46. In addition, the fifth buffer 2258 is connected to the image board 84B which processes the data D4 of the mark camera 47.

The control section 228 regards the data ranging from the divided data DD which has the same identification information ID and in which the start bit information SI is set to the divided data DD in which the start bit information SI is subsequently set, as one data. FIG. 6 illustrates an example of a state of the second buffer 126, however, since the fourth buffer 223 on the receiver-side is also the same as the second buffer 126, the fourth buffer 223 will be described with reference to FIG. 6. In the example illustrated in FIG. 6, the data stored in the data region from the addresses AD1 to AD10 is the data D3 which is continuously transmitted twice from the component camera 46, and the identification information ID of the respective addresses AD1 to AD10 is identical. In addition, the start bit information SI of the address AD1 indicates “the start bit S1 present”, and the start bit information SI of the addresses AD2 to AD5 indicates “the start bit S1 absent”.

For example, when detecting that the start bit information SI of the address AD1 indicates “the start bit S1 present”, the control section 228 processes the data from the address indicating the start bit is present to the address immediately preceding an address indicating a different identification information ID and the start bit information SI to that of the subsequent address AD2, as one block of data. More specifically, the control section 228 detects that the identification information ID and the start bit information SI of the addresses AD2 to AD5 have the same value (“P” and “S1 absent”). Next, the control section 228 detects that the start bit information SI of the address AD6 indicates “the start bit S1 present”. In this case, the control section 228 determines that, out of the addresses AD1 to AD10, the addresses AD1 to AD5 represent one data D3.

The control section 228 performs control for continuously transmitting the divided data DD of the addresses AD1 to AD5 of the fourth buffer 223 to the fifth buffer 225A, based on that a value indicating “P” is set in the identification information ID. At this time, the control section 228 performs a process of removing the identification information ID and the start bit information SI from the data stored in the data region of the addresses AD1 to AD5, and transmits the multiple divided data DD to the fifth buffer 225A. In this manner, the data D3 rebuilt from the multiple divided data DD is stored in the fifth buffer 225A. According to this configuration, based on the value set in the identification information ID and the start bit information SI, the control section 228 can only select one data D3 (from the first start bit S1 to the end bit E1) from two data D3 continuously stored in the addresses AD1 to AD10 of the fourth buffer 223, and can rebuild the data D3 by outputting the data D3 to the fifth buffer 225A. In addition, the receiver-side does not detect and process the bit value (the start bit S1, the end bit E1, or the like), and the control section 228 can process the data D3 continuously transmitted as individual data.

If the control section 228 completes the write process, the image board 84A performs a process of reading the data D3 accumulated in the fifth buffer 225A. Accordingly, the image board 84A can perform the read process after the control section 228 completes the process of removing the identification information ID and the start bit information SI and each data D3 is reliably stored in the fifth buffer 225A. Similarly, based on the identification information ID and the start bit information SI, the control section 228 rebuilds the data D4 by outputting the data D4 to the fifth buffer 225B from the multiple divided data DD accumulated in the fourth buffer 223. The image board 84B performs the process of reading the data D4 accumulated in the fifth buffer 225B. In this manner, according to the communication system 110, the data D3 and D4 of the respective cameras 46 and 47 are transmitted to the data region of the frame 200 corresponding to the time slot allocated to the same input port 121C and output port 221C of the multiplexing devices 121 and 221. In addition, the optical wireless devices 91 and 92 temporarily divide the data D3 and D4 input from the cameras 46 and 47 into the divided data DD, accumulate the divided data DD in the second buffer 126 or the like, and transmit the divided data DD, thus, the receiver-side can rebuild and output the divided data DD. When the data D3 and D4 are written on each of the fifth buffers 225A and 225B from the fourth buffer 223, if the image boards 84A and 84B perform the read process for the fifth buffers 225A and 225B, the control section 228 performs timing adjustment such as performing the write process after a predetermined time elapses.

According to the present embodiment described above in detail, the following advantageous effects can be obtained.

<Advantageous Effect 1> The optical wireless device 92 illustrated in FIG. 4 includes the data extraction sections 123A and 123B which extract the data D3 and D4 output from the respective cameras 46 and 47, based on the start bits S1 and S2 of the respective data D3 and D4. The data D3 and D4 extracted by the data extraction sections 123A and 123B are respectively accumulated in the first buffers 125A and 125B which are disposed corresponding to each of the cameras 46 and 47. Based on the write request signal of the first buffers 125A and 125B, the control section 128 of the optical wireless device 92 selects any one of the respective buffers 125A and 125B, and outputs the data D3 and D4 accumulated in the first buffers 125A and 125B to the second buffer 126. At this time, the control section 128 adds the identification information ID to the data D3 and D4 indicating from which out of the cameras 46 and 47 the data is obtained, and stores the data D3 and D4 in the second buffer 126 (refer to FIG. 6). The multiplexing device 121 of the optical wireless device 92 performs the time division multiplexing for the data D3 and D4 and the identification information ID which are accumulated in the second buffer 126 and are input from the input port 121C to the multiplexing device 121, together with the data D1 and D2 input from the other input ports 121A and 121B and transmits the multiplexed data as the frame 200. According to this configuration, both the data D3 and D4 of the cameras 46 and 47 can be accumulated in the first and second buffers 125A, 125B, and 126, and can be output to one input port 121C. In this manner, the data D3 and D4 can be collectively input to one input port 121, that is, the data D3 and D4 can be collectively arranged in the data region corresponding to the same time slot of the frame 200 which is subjected to time division multiplexing. As a result, a blank period having no data D3 and D4 in spite of the allocated time slot is shortened, thereby allowing the transmission line 95 to perform efficient data transmission.

<Advantageous Effect 2> The multiplexing device 221 of the optical wireless device 91 illustrated in FIG. 8 divides the frame 200 transmitted from the multiplexing device 121 of the optical wireless device 92 by each time slot, and outputs the data D3 and D4 and the identification information ID from the output port 221C to the third buffer 222. Based on the identification information ID added to the respective data D3 and D4, the control section 128 of the optical wireless device performs control for outputting the data D3 and D4 accumulated in the third buffer 222 to the corresponding image boards 84A and 84B via the fourth buffer 223 and the fifth buffers 225A and 225B. According to this configuration, the transmission line 95 is allowed to perform efficient data transmission, and the data D3 and D4 which are collectively arranged in one time slot can be properly transmitted to the image boards 84A and 84B which correspond to the cameras 46 and 47 based on the identification information ID.

<Advantageous Effect 3> The control section 128 divides the data D3 and D4 accumulated in the first buffers 125A and 125B into the multiple data regions of the second buffer 126, and stores the data D3 and D4 as the divided data DD (refer to FIG. 6). At this time, the control section 128 adds the start bit information SI to the multiple divided data DD indicating in which divided data DD the respective start bits S1 and S2 of the data D3 and D4 are included. The divided data DD is multiplexed into the frame 200, and is transmitted to the optical wireless device 91 through the transmission line 95. Each divided data DD is accumulated in the fourth buffer 223 of the optical wireless device 91, similarly to the second buffer 126. Based on the start bit information SI provided by the transmitter-side, the control section 228 rebuilds the data D3 and D4 from the multiple divided data DD accumulated in the fourth buffer 223, and outputs the data D3 and D4 to the fifth buffers 225A and 225B. According to this configuration, the data D3 and D4 are divided into the divided data DD having a fixed bit width, and are accumulated, thus, it becomes easier to control the memory of the second buffer 126 which functions as FIFO.

The disclosure is not limited to the above-described embodiment and may be improved or modified in various ways within the scope not departing from the gist of the disclosure. For example, in the above-described embodiment, the optical wireless communication has been described as an example, but the disclosure is not limited thereto and can also be applied to wireless communication using other various electromagnetic waves such as infrared or visible light. In addition, the disclosure can be similarly applied to wired communication, for example, optical communication through optical fiber networks.

In addition, without being limited to the time division multiplexing system, the multiplexing communication between the optical wireless devices 91 and 92 may employ communication using other types of multiplexing, for example, such as frequency division multiplexing (FDM) and wavelength division multiplexing (WDM).

In addition, in the above-described embodiment, the data extraction sections 123A and 123B are individually disposed for each of the cameras 46 and 47. However, a configuration may be adopted in which one data extraction section processes the data D3 and D4 of the two cameras 46 and 47.

### (Information Storage Section and Programmable Logic Device)

In addition, although not particularly described in the above-described embodiment, the data extraction sections 123A and 123B may be configured to include a programmable logic device, for example, field programmable gate array (FPGA) 140, and a circuit configuration may be reconfigured in accordance with a connected device (cameras 46 and 47 or the like). For example, as illustrated in FIG. 4, the control section 128 is connected to the connectors 22A to 22D which are connected to the respective devices 43A, 45, 46, and 47. For example, the connectors 22C and 22D include a storage element such as a memory or the like, which stores information relating to the data format of the data D3 and D4 or information relating to models and the like of the cameras 46 and 47. Based on the information stored in the memory of the connectors 22C and 22D, the control section 128 reads a program corresponding to the data D3 and D4, outputs the data D3 and D4 to the FPGA, and reconfigures the data extraction sections 123A and 123B. Alternatively, a program for configuring the data extraction sections 123A and 123B corresponding to the data D3 and D4 may be stored in each memory of the connectors 22C and 22D. According to this configuration, even when the cameras 46 and 47 connected to the optical wireless device 92 are changed, the control section 128 causes the FPGA to automatically configure the data extraction sections 123A and 123B corresponding to the data D3 and D4 output from the respective connectors 22C and 22D, thereby enabling the data D3 and D4 to be extracted.

In addition, in the above-described embodiment, a configuration may be adopted in which the data D3 and D4 are accumulated in the second buffer 126 or the fourth buffer 223 without dividing the data D3 and D4. In addition, in the above-described embodiment, the electronic component mounting device 10 which mounts the electronic components on the circuit board has been described, but the disclosure is not limited to this and can be applied to an automatic machine or the like which is operated in various other production lines. For example, the disclosure may be applied to an automatic machine which carries out assembly work of secondary batteries (solar cells, fuel cells, or the like) and the like. In addition, without being limited to those which carry out mounting work or assembly work, the disclosure may also be applied to cutting machine tools, for example, as an automatic machine.

In addition, the configuration of the mounting device 10 according to the above-described embodiment is an example, and can be appropriately modified. For example, a configuration may be adopted which includes multiple moving devices 23 detachably attached to the device body 11. In addition, for example, a configuration may be adopted which includes multiple conveyor belts 31 (multiple lanes). In addition, for example, a configuration may be adopted in which multiple mounting devices 10 are connected to each other in the conveyance direction so as to be driven.

Incidentally, the component camera 46 and the mark camera 47 are provided as an example of the transmitter-side electric device; the image boards 84, 84A, and 84B are provided as an example of the receiver-side electric device; the optical wireless devices 91 and 92 are provided as an example of the transmitter-side and receiver-side multiplexing device; the multiplexing communication system 110 is provided as an example of the communication system; the first buffers 125A and 125B are provided as an example of the first buffer; the second buffer 126 is provided as an example of the second buffer; the third to fifth buffers 222, 223, 225A, and 225B are provided as an example of the receiver-side buffer; the memory of the connectors 22C and 22D is provided as an example of the information storage section; the start bits S1 and S2 are provided as an example of the start bit; the identification information ID is provided as an example of the identification information; the divided data DD is provided as an example of the divided data; and the start bit information SI is provided as an example of the start bit information.

### REFERENCE SIGNS LIST

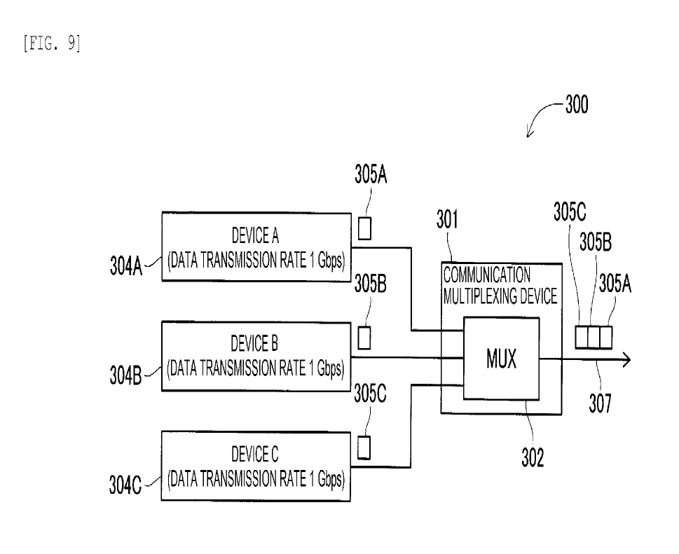

22C, 22D: CONNECTOR; 46: COMPONENT CAMERA; 47: MARK CAMERA; 84, 84A, 84B: IMAGE BOARD; 91, 92: OPTICAL WIRELESS DEVICE; 110: MULTIPLEXING COMMUNICATION SYSTEM; 125A, 125B: FIRST BUFFER; 126: SECOND BUFFER; 222: THIRD BUFFER; 223: FOURTH BUFFER; 225A, 225B: FIFTH BUFFER; S1, S2: START BIT; ID: IDENTIFICATION INFORMATION; DD: DIVIDED DATA; SI: START BIT INFORMATION SI
FIG. 1
X-AXIS DIRECTION
Y-AXIS DIRECTION
FIG. 2
X-AXIS DIRECTION
Y-AXIS DIRECTION
FIG. 3
13: DISPLAY DEVICE
15: FEEDER-TYPE SUPPLY DEVICE
15A: TAPE FEEDER
16: TRAY-TYPE SUPPLY DEVICE
21: CONVEYANCE DEVICE
22: MOUNTING HEAD
23: MOVING DEVICE
32: BOARD HOLDING DEVICE
33: ELECTROMAGNETIC MOTOR
42: POSITIVE AND NEGATIVE PRESSURE SUPPLY DEVICE
43: NOZZLE RAISING AND LOWERING DEVICE
43A: ELECTROMAGNETIC MOTOR
44: NOZZLE ROTATING DEVICE
45: POSITION DETECTION SENSOR
46: COMPONENT CAMERA
47: MARK CAMERA
56: ELECTROMAGNETIC MOTOR
60: ELECTROMAGNETIC MOTOR
80: CONTROL DEVICE
82: CONTROLLER
84: IMAGE BOARD
85: DRIVE CONTROL BOARD
86: I/O BOARD
91: OPTICAL WIRELESS DEVICE
92: OPTICAL WIRELESS DEVICE
FIG. 4
22: MOUNTING HEAD
43: NOZZLE RAISING AND LOWERING DEVICE
43A: ELECTROMAGNETIC MOTOR
45: POSITION DETECTION SENSOR
46: COMPONENT CAMERA
47: MARK CAMERA
92: OPTICAL WIRELESS DEVICE
121: MULTIPLEXING DEVICE
123A: DATA EXTRACTION SECTION
123B: DATA EXTRACTION SECTION
125A: FIRST BUFFER
125B: FIRST BUFFER
126: SECOND BUFFER
128: CONTROL SECTION
FIG. 5
TIME T
COMPONENT CAMERA 46 (CONNECTOR 22C)
MARK CAMERA 47 (CONNECTOR 22D)
FIG. 6
S1 PRESENT
S1 ABSENT
S2 PRESENT
S2 ABSENT
COMPONENT CAMERA
MARK CAMERA
FIG. 7
SERVO CONTROL INFORMATION (FIRST)
SERVO CONTROL INFORMATION (ONE SAMPLE BEFORE, THIRD)
SERVO CONTROL INFORMATION (SECOND)
FAST I/O SIGNAL
SLOW I/O SIGNAL
IDENTIFICATION INFORMATION ID
DATA DATA1
DATA D1
DATA D2
DATA OF SECOND BUFFER (DATA D3 AND D4)
FIG. 8
80: CONTROL DEVICE
85: DRIVE CONTROL BOARD
86: I/O BOARD
84A: IMAGE BOARD
84B: IMAGE BOARD
91: OPTICAL WIRELESS DEVICE
221: MULTIPLEXING DEVICE
222: THIRD BUFFER
223: FOURTH BUFFER
225A: FIFTH BUFFER
225B: FIFTH BUFFER
228: CONTROL SECTION
FIG. 9
301: COMMUNICATION MULTIPLEXING DEVICE
304A: DEVICE A (DATA TRANSMISSION RATE 1 Gbps)
304B: DEVICE B (DATA TRANSMISSION RATE 1 Gbps)
304C: DEVICE C (DATA TRANSMISSION RATE 1 Gbps)

1. A communication system comprising:
multiple electric devices that output actual data in which a start bit indicating data starting is set;
a data extraction section that is connected to the multiple electric devices, and that extracts the actual data based on the start bit;
multiple first buffers that are disposed corresponding to each of the multiple electric devices, and that accumulate the actual data extracted by the data extraction section corresponding to the multiple electric devices;
a second buffer that sequentially selects one of the multiple first buffers, and that accumulates the actual data accumulated in the selected first buffer together with identification information of the electric device which outputted the actual data; and
a transmitter-side multiplexing device that inputs the actual data and the identification information from the second buffer and transmits the actual data and the identification information as multiplexed data.

2. The communication system according to claim 1, further comprising:
a receiver-side multiplexing device that has multiple output ports, and that outputs the actual data and the identification information which are obtained by dividing the received multiplexed data to the output ports; and
a receiver-side buffer that outputs the actual data to a receiver-side electric device which corresponds to the multiple transmitter-side electric devices, based on the identification information output from the output ports.

3. The communication system according to claim 2,
wherein the second buffer divides the actual data output from the first buffer into multiple divided data, adds start bit information indicating whether the start bit is included therein to each of the multiple divided data, and accumulates the multiple divided data, and
wherein the divided data and the start bit information are input to the receiver-side buffer from the output ports, and the receiver-side buffer rebuilds the actual data from the multiple divided data, based on the start bit information which is set in the divided data.

4. The communication system according to claim 1,
wherein the multiple electric devices include an information storage section which stores information relating to the start bit, and
wherein the communication system further comprises a programmable logic device, which is configured from the data extraction section based on configuration data corresponding to the acquired information relating to the start bit, that acquires the information relating to the start bit from the information storage section.

5. An electronic component mounting device that transmits data relating to work for mounting an electronic component on a board using the communication system according to claim 1.
